(19) United States
(12) Patent Application Publication
(10) Pub. No.: US 2024/0420116 A1
(43) Pub. Date: Dec. 19, 2024

(54) NFT-BASED SPORTS PLAYER SCOUTING RECORDS

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,030

(22) Filed: May 20, 2024

Related U.S. Application Data
(60) Provisional application No. 63/467,686, filed on May 19, 2023.

(51) Int. Cl. G06Q 20/36; G06Q 40/06

(52) U.S. Cl. CPC G06Q 20/3672; G06Q 40/06; G06Q 2220/10

(57) ABSTRACT

A subscriber establishes or acquires an NFT token concerning a specific sports player. The subscriber can be a player, a coach, a fan, a sports writer, advertiser, or the like. The player history is updated on the NET token by different data sources. An NFT engine mints NFT tokens and processes and secures transactions. The NFT token can be accessed by a third party to review and use embedded data for player scouting, advertising, promotion and other purposes.

### CROSS-REFERENCE TO RELATED APPLICATIONS

The invention claims priority under 35 USC 119 (e) to 63/467,686, entitled NFT-BASED SPORTS PLAYER SCOUTING RECORDS, and filed May 19, 2023, by Ramde et al., the contents of which are hereby incorporated in its entirety.

### FIELD OF THE INVENTION

The invention relates generally to computer networks, and more specifically, to capturing sporting performances for sports players that is verifiable and more reliable using a non-fungible cryptographic token (NFT) based scouting records.

### BACKGROUND

One of the challenges that sports or university teams face is identifying new players. Major league teams, for example, send scouts throughout the world to try to identify kids that are often teenagers in youth leagues where there are dozens of teams with dozens of players. The identification of good players in baseball, or other sports such as soccer, hockey, golf, basketball, football and the like, can be challenging, uncertain and expensive. The cost of hiring and sending scouts or evaluators to look around, plus the cost of signing unknown prospects two large contracts can be a costly issue for teams.

At the same time, scouts need to be on site to catch the prospect playing well. If the scout is not there, then the player might not get the recognition he deserves. Often, large leagues or events are formed where Scouts are invited from all over to come see a player. While this does not give any one team a competitive advantage, since they are all looking at the same player at the same time, it is challenging for teams to uncover or discover new talent on their own rather than in a competitive situation where all the other teams are looking at the same player. What's evolved is a process where parents and coaches will capture videos, post pictures and try to promote their kids or players directly to colleges and teams or over social media (where there is a lot of noise and other promotions taking place). At the same time, capturing a video and sending it in can often be biased or unreliable. And the parents, players and coaches have to work to capture these images, where if they aren't there the images aren't captured and the recognition of their kid playing a sport might not be recognized. Alternately, on the selection day, an athlete may or may not perform to their full potential based on many physical, psychological, or other factors. As such, scouts evaluate them on the basis of the day's performance, rather than looking at their entire available record over the years. The main reason is that the records can be unreliable, fragmented over various databases or websites, or not even professionally stored with no authentic or objective way to evaluate the available records.

Therefore, what is needed is a more reliable approach for capturing sporting performances for sports players that is verifiable and reliable using NFT-based scouting records.

### SUMMARY

To meet the above-described needs, methods, computer program products, and systems for capturing sporting performances for sports players that is verifiable and reliable using NFT-based scouting records.

In one embodiment, a subscriber establishes an NFT token concerning a specific sports player. The subscriber can be a player, a coach, a fan, a sports writer, promoter, advertiser, sponsor, schools, university, professional league, or the like. The player history is updated as an NFT token by different data sources. An NFT engine mints NFT tokens and processes and secures transactions. The NFT token can be accessed by a third party to review and use embedded data for player scouting and other purposes.

In one embodiment, the data may include their name, organization, business unit, whether they are athletes, coaches, scouts, venue employees or contracted workers, sponsors, university, leagues, or any other information regarding their status with the sports industry. In addition to a user wallet, the system may also create a decentralized identity for the users. This decentralized identity can further be associated with the user's external accounts such as a third-party loyalty rewards program, or a social network etc.

In one embodiment, the system is governed by configurable smart contracts. It is envisioned that the sports ecosystem comprising athletes, coaches, sponsors, venues, scouts, universities, leagues etc. are all incentivized to transact within a customized network. It may be desirable from a business and convenience perspective that the digital assets may only be traded and governed by the rules in the smart contract(s). In one embodiment, the digital assets may be blocked from trading on any third-party systems, exchanges, protocols etc., thereby making it a singular registry of sports data and digital assets related to sports.

Advantageously, the invention presents a more reliable approach to identify sports players from NFT-based scouting records.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for capturing sporting performances for sports players that is verifiable and reliable using NFT-based scouting records, according to an embodiment.

FIG. 2 is a high-level block diagram illustrating an architecture of the NFT Engine and its components, according to an embodiment.

FIG. 3 is a block diagram illustrating an exemplary architectural view of a sports NFT marketplace and applications, according to an embodiment.

FIG. 4 is a block diagram illustrating the elements of the LogicWare with artificial intelligence, blockchain and Web3 interfaces, according to an embodiment.

FIG. 5 illustrates the use of verified credentials (VCs) for authentication into the ecosystem of applications for access control or user onboarding features, according to an embodiment.

FIG. 6 is a more detailed block diagram illustrating a sports player scouting module, of the system of FIG. 1, according to an embodiment.

FIG. 7 is a high-level flow diagram illustrating a method for capturing sporting performances for sports players that is verifiable and reliable using NFT-based scouting records, according to one embodiment.

FIG. 8 is a more detailed flow diagram illustrating an alterative method for capturing sporting performances for sports players that is verifiable and reliable using NFT-based scouting records, according to one embodiment.

FIG. 9 is a block diagram illustrating an example computing device for the system of FIG. 1, according to one embodiment.

### DETAILED DESCRIPTION

Methods, computer program products, and systems for capturing sporting performances for sports players that are verifiable and reliable using NFT-based scouting records with location-based event-triggered cryptographic tokens for gated access to location-based (or position-based). One of ordinary skill in the art will recognize many alternative embodiments that are not explicitly listed based on the following disclosure.

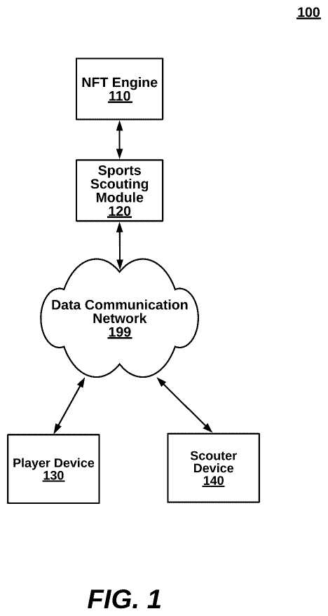

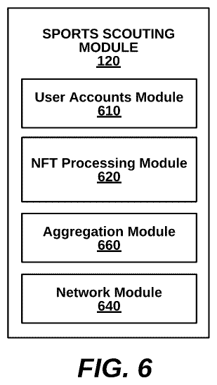

### I. Systems for NFT-Based Sports Player Scouting (FIGS. 1-6)

FIG. 1 is a high-level block diagram illustrating a system 100 for capturing sporting performances for sports players that is verifiable and reliable using NFT-based scouting records, according to one embodiment. The system 100 includes an NFT engine 110, a sports player scouting module 120 interacting over a data communication network 199 with a player device 130 and a scouter device 140, as users of the system 100. In one embodiment, the NFT engine 110 and the sports scouting module 120 are integrated into a single physical device, and in another embodiment, communicate across the data communication network 199. Many other variations are possible.

In one embodiment, the NFT engine 110 mints and allocates tokens based on location-triggered events and providing access to token-gated content, in response to a user satisfying specified token criteria. The NFTs can also be minted in accordance with other operational or marketing objectives—for example as part of a fan voting experience for athletes, or as a membership in a DAO (decentralized autonomous organization). If fan voting is to be restricted to fans inside the stadium, or a particular college, or university, the location triggered module can be optionally integrated. Other ways of minting the tokens include but are not limited to:
a. promotional NFTs for the athlete's prior events, event play or event highlights;
b. live NFT drops during the duration of an event in which the athlete is a participant, or the game that may optionally be tied to other activities in the stadium or the arena such as a meet and greet opportunity with the athlete, team, or other talent;
c. highlight reels after the event. These can be created by the athlete, the fans (as user generated content), or they may be created from the official footage from the events that an athlete participates in;
d. Coach NFTs: coaches involved with the athlete's trainings may mint NFTs or digital assets and make them available on a marketplace. For authenticity, all such NFTs or digital assets that have been validated by the coaches may rank higher in their authenticity and perceived value as coaches are expected to be unbiased in their opinions about the on-field achievements of their athletes.
e. Promotional NFTs for in between events that can optionally be integrated with loyalty programs to encourage fan reengagement and reward them with digital assets for their loyalty towards athletes, teams, sponsors or other ecosystem participants;
f. Auctions: The platform can put a specific item up for auction, with the highest bidder being awarded an NFT. This can be particularly effective for rare or one-of-a-kind items;
g. Collaborations: A collaborative NFT may involve collaborating with other brands, artists, or creators to create unique NFTs that combine their styles or content. These can also be sponsored by some advertisers wishing to reach a particular demographic, based on their data and behavioral patterns. For example, a golf apparel company may sponsor an athlete and release a limited set of NFTs featuring the athlete;
h. Exclusive releases: This involves releasing a limited number of NFTs for a specific event or occasion, such as a music festival or movie premiere, that may be only accessible to certain athletes or certain teams.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated or offered for sale. For example, once minted, an NFT can be offered for sale or acquisition via an NFT marketplace or other token sale/distribution platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, closed to external sources. This can be problematic when external data is needed to satisfy conditions or functions of the smart contract.

By using a blockchain-based system and specifically NFTs for scouting athletes can promote more effective outcomes during athlete meetups and the ecosystem participants could manage or grant access to athlete records to others as needed. The decentralized nature of blockchain could also make it more difficult for unauthorized individuals to access or tamper with athlete records. Moreover, blockchain-based resource and communication tools could facilitate data sharing between different teams, such as schools, universities, leagues, professional associations, sponsors, and other professional organizations, etc. helping to improve coordination, experience and reduce scouting judgements, biases, or errors etc. Additionally, the use of smart contracts on a blockchain could potentially automate various aspects of the scouting journey for teams, organizations, scouts, and the athletes etc. such as for quickly gathering information regarding athlete contributions by or to a team or project supported by verifiable data claims processing or sponsorship tracking. Finally, the use of NFTs incentivizes the holders of the NFTs with recognition and rewards while reinforcing positive behaviors, skills or outcomes for natural communities of said athletes, organizations, sponsors, and other ecosystem participants, who could all benefit from sharing in the development of the athlete.

Any athlete achievements that are minted as NFTs may be bound to a smart wallet address or the same smart contract used for creating a collection or a series of the NFTs as collectibles. Logicware also enables the bundling of these NFTs into diversified portfolios based on preferences like price, statistics, or teams, leagues etc. In addition, the NFT minting may be attested to by the coach or another reliable third party. Attestation can additionally be recorded immutably on a blockchain.

As discussed above, the data associated with generating NFTs can be attested. Such attestation can be optionally recorded on a blockchain. Such attestation enables users to verify and attest to real-world information and data on the blockchain. It allows for the creation of secure, privacy-preserving attestations that can be used for various purposes, such as identity verification, credential issuance, and data authentication. By leveraging attestations on a blockchain, organizations and individuals can establish trust and transparency in the verification process, as the attestations are recorded in an immutable and tamper-proof manner. This can have significant implications for sectors like finance, healthcare, and education, where reliable attestations of identities, credentials, and data are crucial.

These attestations can simply be implemented using the NFT Engine and Logicware platform that provides a combination of smart contracts, and off-chain data storage:

Off-Chain Data Storage: The actual sensitive datasets or documents that need to be attested (e.g., AI models or training datasets, weights, identity documents, credentials, or records etc.) are stored off-chain in a secure storage facility such as a cloud environment or a decentralized storage such as IPFS.

Hashing and Encryption: The off-chain data is hashed using cryptographic hash functions, and the resulting hash is encrypted using the public key of the attesting entity (e.g., an enterprise user who wants to submit the attestation).

Smart Contracts: A set of smart contracts deployed via the Logicware manage the attestation process. These contracts handle tasks such as registering and authorizing attesting entities, storing and verifying encrypted hashes of attested AI datasets or AI models, and issuing and revoking attestations. In addition, the Logicware platform provides APIs for attestation verification.

Attestation Issuance: When an entity wants to attest to a piece of data or document, they encrypt the hash of the datasets or the AI models using their private key and submit it to the smart contracts. The contracts record the attested hash on the blockchain, along with metadata about the attesting entity and the attestation type.

Attestation Verification: To verify an attestation, the interested party (e.g., a service provider or another entity) can use the Logicware APIs to query the smart contracts, providing the encrypted hash and attestation metadata. The smart contracts can then confirm if the attestation exists and is valid, without revealing the actual underlying data, AI datasets or AI models.

Data Retrieval: If the attestation is valid, the interested party can retrieve the encrypted hash from the blockchain and use the attesting entity's public key to decrypt it. They can then compare this hash against the hash of the AI datasets or AI models they have, confirming its authenticity and integrity.

By leveraging smart contracts, cryptographic hashing, and off-chain data storage, Logicware platform enables secure and privacy-preserving attestations on the blockchain.

The platform of the invention takes the complexity of the blockchain environment and abstracts it into a set of APIs and SDKs that can manage the entire process easily. For example, crypto wallets are front end technologies that require user interaction and input to mint an NFT from a smart contract. NFTB has turned it around and made it into a backend and middleware technology (called LogicWare), by managing the complexity away from the user and providing for interaction via APIs and SDKs. As such any front end application can now interact with the blockchain without burdening the users with the intricacies of storing or managing their private keys and authorizing transactions to sign transactions to interact with the blockchains and mint, redeem, or create NFTs. A proxy process can be deployed in the backend that abstracts the user signatures as part of the transaction. At the backend, the transactions can also be handled by custodial wallets, or multi-signature wallets that can associate the transactions to the user accounts. The backend is can support multiple applications simultaneously and while each application may be deployed by a unique customer. The NFT engine 110 maps the backend databases, digital assets, and the blockchain layer interaction to provide a simple workflow for businesses and enterprises.

It may be noted that the LogicWare also provides for creating wallets with various ways of protecting the private keys. The private keys can be stored on a Hardware Security Module (HSM), or in Key Management Systems (KMS), whose keys may be further entrusted to an encrypted vault. The keys can also be managed using a multi-party computation (MPC) process that enables multiple parties to jointly compute a function without revealing their private inputs to each other. As part of the key management contemplated by this invention, LogicWare can distribute the private key across multiple parties in a way that ensures that no single party has access to the full private key. Instead, each party holds a share of the private key, and only by combining all shares can the full private key be reconstructed. Finally, irrespective of the key security mechanism described above, if at any time, a holder of the private key so desires, they can take complete control of their private keys via LogicWare.

For users of such a system, it is important that the system should be easy to use and provide for secure authentication. From a compliance perspective it is also important that the system not allow for deconstruction of personal identities based on their sports records. As such, authentication plays an important role. An authentication module can optionally store login information and authenticate users against the blockchain information. As detailed below, the system can deploy decentralized IDs to enable selective disclosure of information or identity attributes. A user's public key may be stored on the blockchain which allows anyone to verify the authenticity of messages, transactions, or other data associated with that identity. A user in the ecosystem (athlete, coach, parent, league, venue, team, etc.) may store identity-related data on the blockchain, such as verifiable claims, which are claims that have been cryptographically signed by them and can be verified by others without revealing any additional information about the identity. Also, Zero knowledge proofs can be implemented to ensure that information about a user can be verified without sharing any personally identifiable information or protected information. Finally, verified credentials can also be deployed to ensure trustworthiness of the system.

A verified credential as part of this invention is a digital representation of a piece of identity-related data that has been cryptographically signed by a trusted authority. These credentials can include things like a person's name, date of birth, address, or athlete records or any other information as defined above relevant to sports, sponsorship, statistics, coaching data, etc. In a DID system, verified credentials are used to help establish trust between different parties. For example, when a user wants to prove their identity to a service provider (team, league, university, records aggregator, etc.), they can present a verified credential that has been issued by a trusted authority such as insurance company, a government agency or any other trusted participant in the ecosystem. The service provider can then cryptographically verify the authenticity of the credential without having to rely on a centralized identity provider. These verified credentials can be stored on the blockchain, along with the decentralized identity and associated public keys. This allows them to be accessed and verified by anyone in the network without the need for a centralized intermediary. Additionally, because the credentials are cryptographically signed, they cannot be tampered with or altered without detection. Overall, verified credentials help to provide a more secure, private, and flexible approach to identity management, enabling individuals and organizations to assert and control their identities without relying on centralized intermediaries.

There are additional advantages of representing sports achievements, credentials, rewards etc. as NFTs. Such representations for sports achievements provides a clear lineage, and interval information when the achievements are traded, or when the athlete may become famous. It may also be recognized by those skilled in the art that the present invention can work in addition to other athlete tracking and monitoring systems, ingesting information from such systems and making it transparent for governance, reporting and audit purposes. Athletes are also part of clubs and leagues. In such cases, the statistics, achievements and records may be represented as separate NFTs by each entity or combined together. The entire history of an athlete's achievements may be represented as a single NFT, or as a set of nested NFTs, where all the NFTs may be grouped and/or owned and/or bound by the same wallet or a smart wallet. It is apparent that with such groupings.

The NFT engine 110 offers a comprehensive set of features designed to enhance user interaction and data security within various physical and digital environments. Location information can be accessed from any device, allowing users to log into web or mobile applications, or 3D metaverse applications powered by gaming engines such as Unity or Unreal, from any location. Geofences can be configured around athletic training facilities, arenas, stadiums, office venues, conference halls, or other venues, restricting system interaction to participants within these physical locations. When users enter a geofenced area, they can interact with the application.

The LogicWare platform, along with APIs and SDKs, supports the development of applications as single web apps, native mobile apps, monolithic client applications, or distributed systems with separate client and server roles for users and admins. The application can be triggered by scanning a QR code, using a specific URL displayed at a venue, automatic backend configuration, receiving an SMS or message, or through single sign-on (SSO) or SAML assertion within another application.

Users can log in with email, social networks, SSO, or SAML assertions, and associate their login details with a blockchain wallet address, storing the corresponding private key. The application can optionally create a decentralized identity wallet for users, with verified credentials mapped to their profile information. This ensures the decentralized identity is associated with a user without revealing personal information.

Users can claim digital assets by presenting their public key to an application configured with a smart contract, with payment options including fiat, cryptocurrency, redeem codes, or through whitelisted wallet addresses. The application can blacklist wallet addresses to block interaction. The system can create NFTs or token records using system private keys or multi-signature techniques, making private keys optional for redeeming assets.

The application is governed by smart contracts, which can be EVM-compatible or custom-developed for specific blockchains like Near or Solana. These smart contracts support unique digital assets (ERC 721), copies of assets (ERC 1155), mixed digital assets (ERC 998), semi-fungible tokens (ERC 3525), and rental of digital assets. Assets created via smart contracts can be imported into metaverse or 3D environments, allowing for the display of certain medical records and images over 3D body scans.

The application can deploy smart contracts on the fly, creating a separate private key/wallet address pair for deployment. This deployment wallet may hold cryptocurrencies and pay for transactions related to digital assets or pass this cost to buyers. The solution can be part of an enterprise deployment, with smart contracts configured and deployed via API calls in real-time, across various blockchains or test environments.

Digital assets created are stored with creative elements like pictures, audio, or video content, and associated data stored as metadata. This data can be stored centrally on internet-connected servers or in a decentralized manner using protocols like IPFS or Arweave. Digital assets may or may not be transferable to other wallet addresses on the blockchain. Payment confirmations, including token IDs, are stored on the blockchain as proof of payment when tokens are minted. NFTs can be issued within one geofenced location and redeemed in another, with additional rules or user requirements layered on top of geofencing rules.

The NFT engine 110, in an embodiment, mints and allocates cryptographic experiential tokens that may be optionally based on a location-based event or based on the triggers and conditions described above and entitling the user to access an experience. In another aspect, token-gated access is granted to a resource at a location based on location triggered events and providing access to token-gated content in response to a user satisfying specified token criteria.

The system 100 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application of electronic services, online services, or software platforms. Devices serving as digital wallets may include location-based services capabilities, e.g., GPS, UWB, BLE, Wifi, NFC, and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions. As such, it is advantageous to create a decentralized identity for the user, so that their personal identity is secure and protected and that their privacy is not subject to unnecessary public scrutiny.

The player scouting module 120, of this embodiment, includes a user accounts module 310 for sports player and coaches, sports scouts and sports fans to interact with a front end of the system 100 with a user interface. An NFT processing module 320 interoperates with the NFT engine 110 and LogicWare as a back end using APIs and other communication techniques, responsive to user instructions. Additionally, automated data reporting service and update processes may interact with the NFT processing module 320 automatically. An aggregation module 330 can quickly draw together similar players, same position players, same region players, and other multi-player presentations and analytics. A network module 340 uses a channel for WiFi, Ethernet or cellular communication over the data communication network 199.

The sports player scouting module 120 captures information during the time of the game, in between games (as fitness data, or practice data), post game, or any other time that an athlete data needs to be captured, relationship, and preferably creates digital certificates, digital assets or NFTs stored on a blockchain. The data and metadata that is used to create the NFTs is stored in a distributed database or a blockchain. Alternatively, the data could be stored in regular databases, and permutations and various combinations of the data can be recorded as NFTs or stored on decentralized storage systems such as IPFS or Arweave, or a hash corresponding to the data can be stored on the blockchain. The user accounts module 310 allows accurate and reliable information about players. At the same time, the aggregation module 330 can recognize the strong (er) players that are generally understood by other teammates, coaches, and parents to be the better players and the better prospects.

The platform provides many avenues for people to get recognition and compensation for their sport prowess on one side, get compensation/recognition/incentivized for posting images/plays on another, have a record of images or events or verify teammates on another side, validate/verify coaches on another side, highlight players/teams/plays efficiently to scouts/teams/universities/advertisers on another side.

Commonly, teammates know which players are pretty good and would be able to identify or want to be able to say “I played with a star player” who may have gone on in the future to have a successful college or professional career or otherwise become well-known. But presently there is no reliable proof other than team pictures to prove that certain athletes played together. At the same time, coaches might not get the recognition for developing the players that they've coached to go on to do successful things in college (e.g., Div I, II or III) or the pros or other leagues. The present platform uses NFTs and digital certificates to incentivize coaching staffs, parents, fans, other teammates and even the players themselves to capture and provide information into the platform. The platform can take an image or video of a star player doing something very well and generate an NFT or verifiable digital record (with metadata). The person who captured the NFT would get recognition on the platform for capturing that information. Others who wish to own or hold the NFT would in effect endorse the success of the play by purchasing, obtaining or holding on to the NFT, as if a physical baseball card or collectible. The platform would also recognize coaching and league staff that upload/verify statistics, even by possibly reimbursing or paying the coach, team or league for doing so. The incentive of a coach to provide statistics or confirm players or confirm the accuracy of a particular play would allow the coach to generate a reputation or a history that the platform could recognize or leverage for the scouts or the university to get comfortable with a particular player, play or team. The NFTs themselves can be based on ERC721, 1155, 998 (composable NFTs), or 4907 (NFT rentals), ERC 6551 (tokenbound account), ERC4337 (smart wallets and gasless minting) or any other standards that may be developed or deployed on any EVM or non-EVM blockchain. NFT standards could also be on any blockchain including but not limited to Ethereum, Polygon, Solana, etc.

As NFTs are uploaded onto the platform or generated from images, audio, video, or any other digital data format including AR/VR/3D modeling etc. Other teammates or participants who provided such digital assets images could get recognition for making the assets available. Teams or leagues could be issued tokens that parents or teammates or other fans of the sport could use to obtain collectibles or NFTs of plays that people could use to prove that they were at the game or provided verification information or recognized early on the potential of a player. This would allow people to build a reputation on their ability to recognize talent, get compensated for verifying data as a parent or a coach for example, or incentives for uploading images that captured a good play or player.

The platform could then be used by colleges or sports leagues, or even by advertisers to target or sponsor players as they are coming through or developing in the system as potential prospects for their business, leagues, team or university. The platform could be available as a subscription service. Popular NFTs can get identified to users or subscribers so that they could look into the veracity or accuracy of the play, the reliability of the coach, prowess of a player, and the like. NFTs could also be leveraged by the platform (based on their popularity or sales and the like) to highlight certain players and their skill sets as those players develop over time.

Popular plays or interesting players could then be displayed on a marketing platform so that added sales track the popularity of the play or desirability of a player. At the same time, many users would want to have NFTs of good players early in their career to confirm their ability to identify players just like a scout would. An aggregate of all such NFTs could be showcased on a NFT marketplace. LogicWare allows for such a marketplace to be agnostic of the underlying blockchain, or NFT protocol and makes it easy for users to trade irrespective of the underlying protocol.

In one embodiment, if a scout identifies a player or team of interest, they could track the performance of that player via NFTs or on the players marketplace rather than having to try to track down data or videos that may be held by many people, but not properly authenticated or verified. An existing problem is that the data may not be available on any centralized system, or on a single database or a centralized platform system that would automatically highlight or allow a scout or university to look and search over or for the historical performance of a player or team. This issue is solved by the present invention as data is made interoperable and easy to find and associate with an athlete's performance. An additional benefit of the invention lies in the fact that a professional team could also track a prospective coach and how well that coach was developing players so that the system could also be used for identifying or verifying the talent of a coach, which is often objectively difficult if not impossible to track.

The platform allows a sponsor to sponsor a league or team or individual player. The sponsorship fees could be the source of funds that could be used to incentivize participants on the platform, from parents, to teammates, to coaches, to fans and the like. At the same time sponsors could sponsor a player or recognize a play as the key play based on the sales of NFTs or voting by NFT owners or just based on the number of downloads or views. Leagues could also get sponsorships by being targeted by hotels and restaurants or transportation providers who would be able to offer volume discounts to those leagues that travel or eat out. NET owners can also elect to be targeted based on the NFTs that they hold and the types of entities that they purchase. NFT users, having spent money or time to obtain NFTs, are a desirable target market for advertisers and team boosters, for example.

NFT owners can elect to be targeted based on the NFTs that they own, the players that they track or collect, or their location. The platform would allow NFT owners to be bid upon or targeted for services or products based on their NFT purchases. This option for NFT owners would allow the NFT owners to control how they are targeted and actually get compensated for their fandom and excitement for a player, sport or league. For example, if a fan has NFTs of a particular team and that fan travels to a new location to watch that team, that fan could allow themselves to be targeted based on their location or their team preference or a restaurant or a discounted meal or travel service.

NFTs can be programmed and designed to self-destruct after a period of time or a certain activity has ended. Self-destruction can be achieved by the user or the platform either by burning the NFT or by transferring it into a previously designated address where it may be locked.

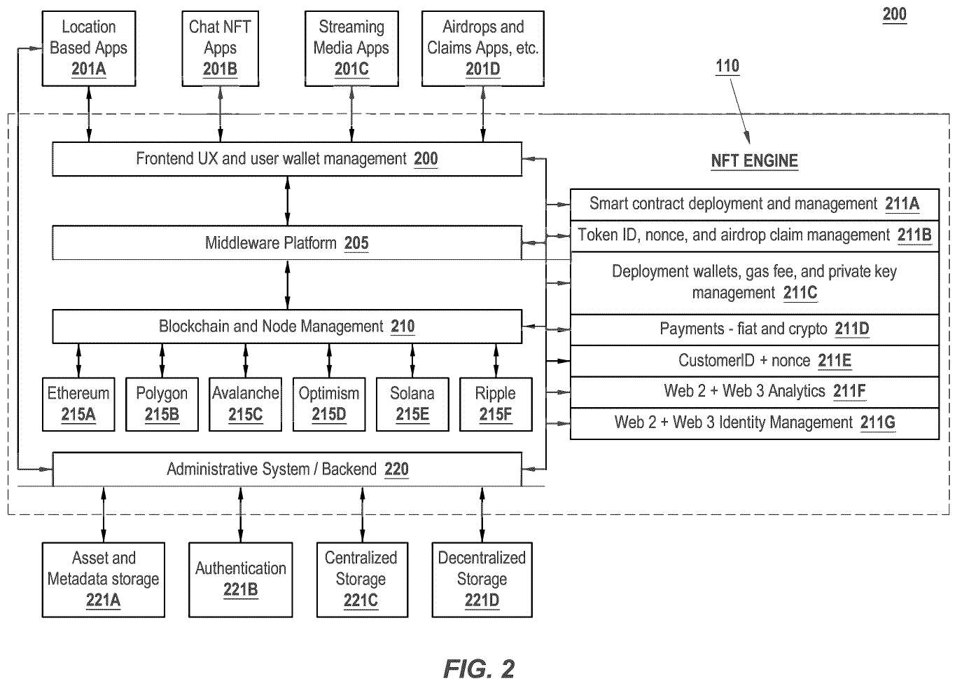

FIG. 2 illustrates one embodiment of a high-level architecture of the NFT Engine 110 and its components 211A-G. Various other components and modules can be added to the NFT Engine to accommodate customized NFT requirements.

System 200 offers a variety of features for supporting various applications 201A-D including location information or user ID that is accessible from a mobile or other device. The NFT engine application can be triggered by scanning a QR code, accessing a specific URL, or being sent to the user as an SMS or message.

The NFT engine application allows users to log in with their email, any social network, or single sign-on service such as Okta. Users can associate their login details with a wallet address on a blockchain (a public key typically) and store a corresponding private key. The private key is a highly confidential key that authorizes transactions on the blockchain, proving ownership of the associated digital assets. The wallet address is the public counterpart, similar to a public address, that serves as a store of digital assets. Users can claim a digital asset by presenting the public key to the application configured with a smart contract, make payments by fiat or crypto, redeem a code, whitelist wallet addresses to mint an asset, and blacklist wallet addresses to block them from interacting with the application.

The NET Engine 212 interfaces with a variety of other software modules including the user experience modules 202 and the core software infrastructure modules 205, 210 and 220. In one embodiment, 201A is a location-based application that is built using the NFT Engine 110. Location based apps 201A could also be a non location-based application or any other generic application that provides blockchain and NFT functionality to the users. Sports scouting apps 201B is another application or module. Other applications from a user experience perspective may be streaming media or digital avatar apps such as 201C or AirDrop and claims applications such as 201D there may be many more applications that can be built on top of the NFT engine. These applications interface directly with the NFT engine via the front end UX and user wallet management modules 200. These applications also interface with an administrative system or a backend 220 which may be specific or customized for each application. The front end UX and user wallet management module 200 is connected to the NFT brewery middleware platform 205 which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum 215A, Polygon 215B, Avalanche 215C, Optimism 215D, Solana 215E, Ripple 215F, or any other EVM or non-EVM blockchain via custom RPCs and APIs. The back end 220 provides support for asset and metadata storage 221A, authentication 221B, centralized storage 221C, or decentralized storage (221D). Other modules and components of the NFT Engine 212 include:
1. Smart contract deployment and management module (211A), that supports any underlying blockchain
2. TokenID, nonce, airdrop claim management modules 211B to ensure individual transactions can be processed out of sequence as well in case certain transactions are held up in the execution queue.
3. Deployment wallets and scripts, wallet management including private key management and gas management 211C, with a variety of ways for managing private keys including encryption, utilizing key vaults, multi-party computation techniques (MPC) or multi-signature wallet management.
4. Payments modules for both fiat as well as cryptocurrencies 211D via payment gateways, integrating recording the transaction results and status directly into the blockchain.
5. CustomerID and Nonce management for individual customers 211E, similar to user side described above, to ensure that transactions by different customers do not queue up and can be processed independently.
6. Integrated web2 and web3 analytics 211F to map transactional information of users to their wallets. In addition, AI techniques and algorithms can be utilized to infer behavioral information about users independent of their demographic information.
7. Integrated web2 and web3 identity management 211G that allows for access controls to be implemented based on the digital wallets, ownership of media or avatars, or any other digital goods or identity modules including SSO, SAML, etc.

The NFT engine 212 mints and allocates cryptographic experiential tokens entitling the user to access an information stored in the blockchain. In another aspect, token-gated access is granted to a resource providing access to token-gated content in response to a user satisfying specified token criteria.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology.

One of the key features of Web3 is the use of smart contracts, which are self-executing contracts with the terms of the agreement directly written into code. Smart contracts enable automated and tamper-proof agreements, facilitating various applications such as decentralized finance (DeFi), non-fungible tokens (NFTs), and decentralized exchanges (DEXs).

Immutable refers to the inability to modify or tamper with data once it has been recorded. Transactions and data recorded on a blockchain are immutable, which means that they cannot be altered or deleted retroactively. This immutability is achieved through cryptographic hashing and the decentralized consensus mechanisms employed by blockchain networks. The immutable nature of blockchains ensures data integrity, transparency, and an auditable trail of all activities, which is crucial for applications requiring tamper-resistant record-keeping and trustless interactions. Data can also be stored immutably over the InterPlanetary File System (IPFS), which uses content-addressing to store immutable data in a distributed file system. This complements the immutable data storage capabilities of blockchains. Data can be stored on IPFS instead of directly on a blockchain due to the significant storage constraints and costs associated with recording large amounts of data on most blockchain networks. By storing the data immutably on IPFS and recording just the content-addressed IPFS hash on the blockchain, applications can leverage the immutability and tamper-resistance of both systems while optimizing for efficient data storage.

Ingesting data is the process of importing assorted data files from one or more sources into a cloud-based or on-premise storage medium, a data warehouse, data mart, InterPlanetary File System (IPFS), decentralized storage network, or any other structured or unstructured database where it can be accessed and analyzed. This process involves extracting data from various sources, transforming it into a compatible format, and loading it into the designated storage or a processing system. Efficient data ingestion mechanisms are crucial for handling large volumes of data from multiple sources in real-time or batch modes. The ingested data can encompass various formats, including text, numerical data, audio, video, and multimedia content. The ingested data can originate from databases, log files, IoT devices, social media platforms, or any other data-generating source, enabling organizations to consolidate and derive insights from diverse data sets. Robust data ingestion pipelines ensure data integrity, scalability, and integration with downstream analytics and processing systems.

A backpack is a cryptographic construct that binds a user's digital identity, data, credentials, or any other digital assets to a non-fungible token (NFT) or other blockchain-based token. This account backpack NFT serves as a secure, portable representation of the user's identity, data, credentials, and other assets across different applications. By leveraging the immutability and trustless characteristics of blockchain technology, the account backpack provides users with self-sovereign control and management of their digital identity and assets within a unified repository while maintaining security, transparency, and an auditable record of account activity.

Binding refers to the cryptographic process of associating a user's digital identity, credentials, assets, or data with a specific blockchain token or non-fungible token (NFT). This binding establishes an inseparable link between the token and the account, ensuring that the account's contents are inextricably tied to the token's ownership and transfer. The binding mechanism leverages cryptographic primitives like digital signatures and hashing to create a secure and verifiable connection between the account data and the fungible or non-fungible tokens. Once bound, the account and its associated data can only be accessed, modified, or transferred by the rightful owner of the corresponding token, as established by the private key/wallet address pair, providing self-sovereign control over the digital assets, identity and credentials.

A series of NFTs may refer to a chronological sequence of recorded activities, actions, or occurrences. Each NFT that is created in the series may be appended as an immutable entry, preserving the order and integrity of the overall series. The series of NFTs therefore allows for a transparent and auditable log of all events that have transpired within a system or process. As such, the system ensures a verifiable history that cannot be retroactively modified, enabling trustworthy record-keeping and traceability of operational activities over time.

An interval represents a specific, finite period or window of time that is consumed or utilized in its entirety. An interval has a defined start and end point. Once an interval has been allocated or assigned for a particular purpose, it cannot be reused or reassigned until it has been fully consumed or expired. This property of intervals ensures exclusivity and prevents overlapping usage conflicts within the designated time window. For example, if data from a particular interval has been converted to an NFT for audit purposes, the same data may not be included in another interval for a second NFT, as it may lead to double counting of the resources utilized in the interval. Such double counting can lead to conflicts and destroy the integrity of the data.

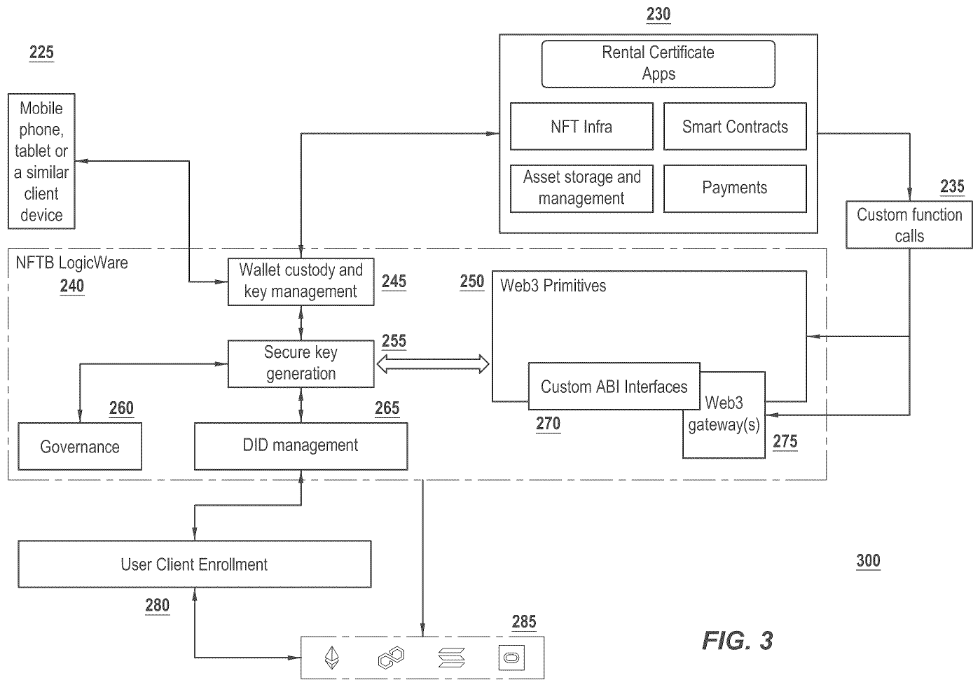

FIG. 3 illustrates an exemplary high level architectural view of a sports NFT marketplace and applications using the current invention. The client in this case can be an athlete, a sports league, school, university, professional association, coaches, or any other entity or a service provider in the ecosystem. Various other components and modules can be added to this architecture to accommodate customized NFT requirements.

The end user may log in into the platform using a mobile phone tablet or similar client device 225. The application running on the device interacts with the NFT middleware platform via the NFTB LogicWare 240. The LogicWare determines the wallet custody and key management protocol, 245, that applies to application 230 or the user and logs the user in into the application. If the user interacts with the application or dApp the first time, the custody and key management protocol 245 generates a new key pair using the secure key generation module 255 or the user and associates it with their identity. Optionally it may also associate the keys with a decentralized identity and issue verified credentials to the user.

Additionally, LogicWare also creates or associates the governance policies that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, etc., asset storage and management (221A, 221C, 221D), or payments 211D.

The application interfaces with the middleware and LogicWare 240 via custom function calls APIs and SDKs 235. The NFTB LogicWare includes various web3 primitives 250 that are interoperable building blocks that are highly reliable in executing transactions over a blockchain, communicate with backend (220) and frontend 200 systems, work with storage components 221C, 221D, utilize analytics from modules such as web2 and web3 analytics 211F, identify users using the identity management module 211G, secure the applications using authentication, identity management, or implement access controls with 211G, 211B, etc. or provide for a governance layer in combination with the governance module 260. The web3 primitives 250, also communicate with custom ABI interfaces, 270, and web3 gateways 275 for deploying smart contracts to their respective blockchains, interacting with smart contracts, and executing the functions and instructions in the smart contracts.

Each of these NFTs is further associated with metadata and wallet address of the users prior to the NFT mint or transfer transaction. It is further noted that the metadata may be provided via an interaction with automated data reporting service processes such as AI agents.

Additionally, AI agents can be used to facilitate automated data reporting service processes that may interact with any of the modules.

AI agents are software programs that employ artificial intelligence techniques to operate autonomously or semi-autonomously in a variety of environments, making decisions based on input data, predefined rules, machine learning models, or a combination of these methodologies. Typically, AI agents perform tasks independently without human intervention, adjusting their actions based on the analysis of incoming data. In this way they are an extension of an analytics engine and make it easy to take actions based on the underlying analysis for the data that they operate upon, such as performance or other informational data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks. The output of AI agents can be information that can be represented as metadata and associated with an NFT. In one embodiment AI agents can be used to process data and create metadata that can be immutably recorded and attached to an NFT.

These AI agents can be implemented using a variety of technical frameworks and methodologies, including but not limited to:
Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

AI agents can be used to facilitate automated data reporting service processes that may interact with the carbon profile module 320 automatically. Such automated data reporting service processes may include:
1. Database services designed to manage, query, and report data from relational, non-relational, or vectorized databases efficiently.
2. Business intelligence tools that collect and process large amounts of unstructured data from internal and external systems, prepare it for analysis, develop queries against that data, and create reports, dashboards, and data visualizations.
3. Data Warehousing Solutions that aggregate data from multiple sources, making it easier to provide comprehensive reporting and analysis. They often include tools for automated reporting and data analysis.
4. AI powered analytics platforms that use artificial intelligence to analyze data and generate reports. They can identify patterns, trends, and anomalies without human intervention.
5. AI agents that meet specific business needs, capable of extracting data from various sources, analyzing it using machine learning models, and generating tailored reports. These agents can be trained to provide insights specific to the sport's operational, tactical, or strategic queries.

These automated data processing reporting services may also include spreadsheet tools with automation features, API based tools, cloud-based reporting services, ETL (extract, transform, load) tools or any combination of the above.

In addition, the LogicWare optionally comprises a governance (260) and a Decentralized Identity (DID) management module (265). DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The Governance module 260 within the NFTB LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module 265 is a part of the web2 and web3 identity management module 211G described above. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module 280 to create a system where the identities from one system may map directly to an identity on another system, without the need for any user intervention. For example, when making a private blockchain system to be compatible with a public blockchain such as Ethereum, Polygon or Solana, it may be essential to create a user (client) enrolment into the Hyperledger based system and map it to the private keys for the eventual user of the system.

### A. Artificial Intelligence for Gathering and Analyzing Sports Player Data

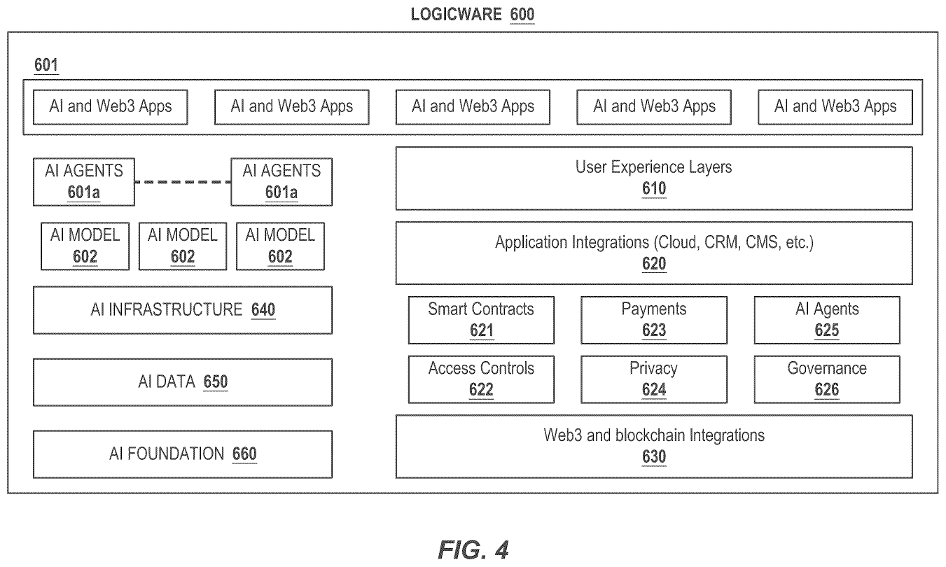

The Logicware system 400 depicted in FIG. 4 abstracts away many of the complexities involved in building and operationalizing AI systems, enabling video chat application developers and applications to focus on leveraging AI capabilities rather than dealing with low-level infrastructure concerns. AI Foundation 660 refers to the underlying platform enabling the integration and deployment of artificial intelligence capabilities within LogicWare 600. The AI Foundation 660 serves as a common layer that provides essential services and components required for developing, deploying, and managing AI models and applications. AI Foundation may be part of the LogicWare 600 deployed as SDKs or made available to Logicware via APIs. AI Foundation may include or support the following key elements:

Data ingestion and preprocessing: Components for collecting, cleaning, and preprocessing data from various sources to prepare it for use in AI models.

Model development and training: Tools and environments for building, training, and evaluating AI models 602, such as machine learning, deep learning, or natural language processing models.

Model management: Services for versioning, storing, and managing trained AI models 602, as well as monitoring their performance and updating them as needed.

Inference and deployment: Mechanisms for deploying trained AI models into production environments, allowing video chat applications and systems to consume and leverage the AI capabilities.

Scalability and performance: Infrastructure 640 and services that enable the efficient scaling and high-performance execution of AI workloads, often involving specialized hardware like GPUs or TPUs and cloud-based services.

Security and governance: Mechanisms for ensuring the secure and compliant use of AI models, including access control, auditing, and adherence to regulatory requirements.

Integration and APIs: Interfaces with Application Integrations 630 and APIs that allow other applications and systems to seamlessly integrate with video chat and consume the AI capabilities provided by the foundation such as process systems 621-626.

AI Foundation 660 aims to provide a standardized and consistent platform for AI development and deployment with Logicware 110, across the organization, promoting reusability, scalability, and governance of AI solutions. Some of the features of the AI Foundation 660, may also integrate with cloud, CRM, CMS and other systems via Application Integrations 620.

AI Data 650 refers to the information used to train and develop artificial intelligence systems. This data can be in various forms, such as text, images, audio, video, or numerical data, depending on the application of the AI system. Ensuring the quality, relevance, and diversity of AI data is crucial for building accurate and unbiased AI models. AI data can be both structured and unstructured.

Structured data refers to information that is organized and formatted in a predefined way, such as databases, spreadsheets, or labeled datasets. This type of data is typically used for tasks like classification, regression, or structured prediction problems.

Unstructured data, on the other hand, refers to information that does not have a predefined format or structure, such as text documents, images, audio files, or social media posts. This type of data requires more preprocessing and feature extraction techniques before it can be used for training AI models.

Many AI applications, especially in areas like natural language processing (NLP) and computer vision, rely heavily on unstructured data, while structured data is more commonly used in fields like finance, healthcare, and manufacturing.

Logicware works with both structured and unstructured data which can also be integrated via application integrations 620.

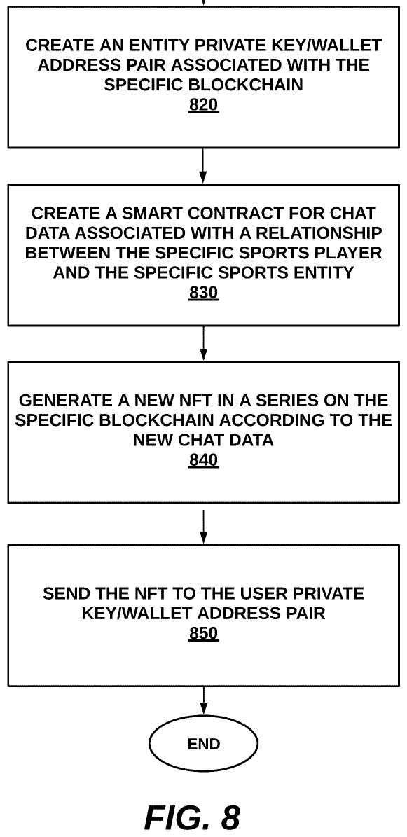

AI infrastructure 640 refers to the combination of hardware and software resources required to develop, train, and deploy artificial intelligence systems effectively. It includes powerful computing resources, such as GPUS, TPUs, or specialized AI accelerators, to handle the computationally intensive tasks involved in training large AI models. AI infrastructure also encompasses the software platforms, frameworks, and tools used for data preprocessing, model building, training, and inferencing, which may also be a part of the AI Foundation. Additionally, AI Infrastructure 640 may involve storage and data management solutions to handle the vast amounts of data required for AI model training. The system in FIG. 8 enables robust AI infrastructure is crucial for organizations to scale their AI initiatives and achieve efficient model development and deployment cycles.

AI models are mathematical representations or algorithms that are trained on data to learn patterns, make predictions, or take actions. They are the core components of artificial intelligence systems that enable them to perform specific tasks, such as image recognition, natural language processing, or decision-making. AI models can be deep learning models, like convolutional neural networks or transformers, or more traditional machine learning models like decision trees or support vector machines. The performance and accuracy of an AI model depend on the quality and quantity of the training data, the model architecture, and the techniques used for training and optimization.

AI agents are software programs that employ artificial intelligence techniques to operate autonomously or semi-autonomously in a variety of environments, making decisions based on input data, predefined rules, machine learning models, or a combination of these methodologies. Typically, AI agents perform tasks independently without human intervention, adjusting their actions based on the analysis of incoming data. In this way they are an extension of an analytics engine and make it easy to take actions based on the underlying analysis for the data that they operate upon, such as carbon credit information data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks. The output of AI agents can be information that can be represented as metadata and associated with an NFT. In one embodiment AI agents can be used to process data and create metadata that can be immutably recorded and attached to an NFT.

These AI Agents can be used to enhance collaboration and extract insights from video chats and meetings. In one embodiment, an AI agent trained on audio and video data ingests audio and video streams in real time or recordings thereof of chats or meetings conducted on platforms such as Zoom. The AI agent extracts spoken dialogue and converts it into text transcripts. The transcribed data is then processed to extract specific information including but not limited to: identifying key points, decisions and action items to generate a summary of the meeting content; analyzing the content for sentiment analysis to gauge a participant's emotional tones and reaction to topics discussed; extracting actionable tasks and items based on a model with training datasets that meet objective criteria for dataset such as for deadlines and follow up items discussed during the conversation; quantifying the time allocated for each participant and understanding patterns for specific participants from a summary or a plurality of such video calls; searching the transcript; generating quantitative and qualitative analytics and reports about the communication dynamic and participation levels of the participants.

Using AI agents, a lot of unstructured data from the calls can also be converted to structured data affiliated with the participants and aid in enhancing the productivity, accountability, knowledge transfer of the organization while enabling a data driven decision making. It is anticipated that the output garnered from such AI agents may be utilized to create specific metadata for NFTs that can engage or reward the participants of such video chats. When used in the context of an employer, these NFTs can be useful to provide highlights from an employee's employment history including their accomplishments. Several rewards for active participation may create an immutable attestation for an employee review.

As discussed above, video chats and communications can be attested. Such attestation can be optionally recorded on a blockchain. Such attestation enables users to verify and attest to real-world information and data on the blockchain. It allows for the creation of secure, privacy-preserving attestations that can be used for various purposes, such as identity verification, credential issuance, and data authentication. By leveraging attestations on a blockchain, organizations and individuals can establish trust and transparency in the verification process, as the attestations are recorded in an immutable and tamper-proof manner. This can have significant implications for sectors like finance, healthcare, and education, where reliable attestations of identities, credentials, and data are crucial.

These attestations can simply be implemented using the Logicware platform that provides a combination of smart contracts, and off-chain data storage.

Off-Chain Data Storage: The actual sensitive datasets or documents that need to be attested (e.g., AI models or training datasets, weights, identity documents, credentials, or records etc.) are stored off-chain in a secure storage facility such as a cloud environment or a decentralized storage such as IPFS.

Hashing and Encryption: The off-chain data is hashed using cryptographic hash functions, and the resulting hash is encrypted using the public key of the attesting entity (e.g., an enterprise user who wants to submit the attestation).

Smart Contracts: A set of smart contracts deployed via the Logicware manage the attestation process. These contracts handle tasks such as registering and authorizing attesting entities, storing and verifying encrypted hashes of attested AI datasets or AI models and issuing and revoking attestations

In addition, the Logicware platform provides APIs for attestation verification.

Attestation Issuance: When an entity wants to attest to a piece of data or document, they encrypt the hash of the datasets or the AI models using their private key and submit it to the smart contracts. The contracts record the attested hash on the blockchain, along with metadata about the attesting entity and the attestation type.

Attestation Verification: To verify an attestation, the interested party (e.g., a service provider or another entity) can use the Logicware APIs to query the smart contracts, providing the encrypted hash and attestation metadata. The smart contracts can then confirm if the attestation exists and is valid, without revealing the actual underlying data, AI datasets or AI models.

Data Retrieval: If the attestation is valid, the interested party can retrieve the encrypted hash from the blockchain and use the attesting entity's public key to decrypt it. They can then compare this hash against the hash of the AI datasets or AI models they have, confirming its authenticity and integrity.

By leveraging smart contracts, cryptographic hashing, and off-chain data storage, Logicware platform enables secure and privacy-preserving attestations on the blockchain.

These AI agents can be implemented using a variety of technical frameworks and methodologies, including but not limited to:
Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

In FIG. 4, system 800 can support a range of AI and Web3 applications via interfaces 601. AI applications can be utilized in a wide range of fields, including computer vision for object detection and recognition, natural language processing for text analysis and generation, predictive analytics for forecasting and decision support systems, as well as robotics and automation for task planning and control. The proposed invention leverages novel AI models and algorithms to achieve improved performance, efficiency, or functionality compared to existing approaches. These applications can find use in a variety of different industries and for numerous use cases such as healthcare diagnostics, financial fraud detection, recommendation systems, language processing, customer service, etc. The AI application can be implemented on various hardware platforms, such as cloud computing infrastructure, edge devices, or specialized AI accelerators, enabling scalable and cost-effective deployment.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

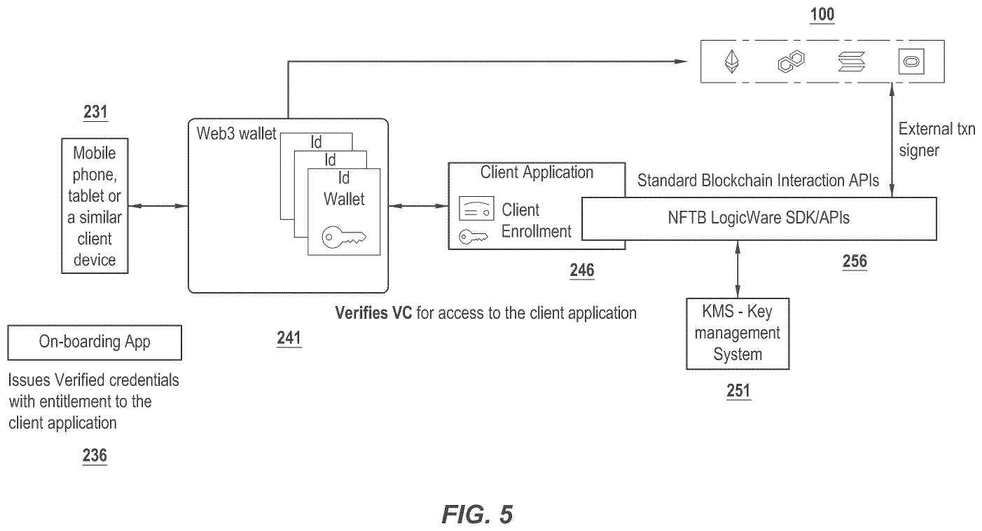

FIG. 5 illustrates the use of verified credentials (VCs) for authentication into the ecosystem of applications for access control or user onboarding features.

When a user logs in to the platform using a mobile phone, tablet, desktop, or a similar device 231 the onboarding application 236 or dApp issues a verified credential (VC), to the user. It may be noted that the VC may be issued by a third-party application separately and imported into the client application. These VCs allow the user to access other connected applications or dApps that the user may wish to, such as loyalty programs, using their decentralized identity. As such verified credentials (VCs) act as an authenticating mechanism for users to use the appropriate wallets as a proxy for their identity on the system. A user may have multiple wallets associated with their identity. When a user logs in to the application or dApp, the LogicWare 256 identifies the appropriate identity to use and retrieves the appropriate keys from the key management system, 251. This in turn allows the application or dApp 246 to transact with the blockchain using the appropriate identity and the private keys associated with them. A user's public key may be stored on the blockchain which allows anyone to verify the authenticity of messages, transactions, or other data associated with that identity.

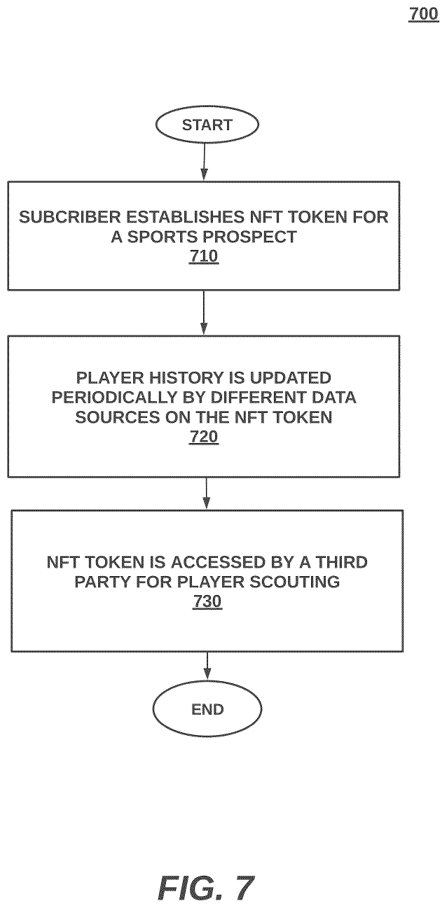

### II. Methods for NFT-Based Sports Player Scouting (FIGS. 7-8)

FIG. 7 is a high-level flow diagram illustrating a method 700 for capturing sporting performances for sports players that is verifiable and reliable using NFT-based scouting records, according to one embodiment. The method 700 can be implemented by, for example, system 100 of FIG. 1.

At step 710, a subscriber establishes an NFT token relationship concerning a specific sports player. The subscriber can be a player, a coach, a fan, a sports writer, advertiser, or the like. At step 720, the player history is updated on the NFT token by different data sources. As such, the NFT can be a dynamic NFT where the player data is recorded and updated in near real time. An NFT engine mints NFT tokens and processes and secures transactions. At step 730, the NFT token can be accessed by the subscriber or optionally be made available to a third party to review and use embedded data for player scouting and other purposes.

FIG. 8 is a more detailed flow diagram illustrating a method 800 for capturing sporting performances for sports players that is verifiable and reliable using NFT-based scouting records.

At step 810, a player private key/wallet address pair associated with a specific player to interact with the system is created. The player private key/wallet address pair is associated with a specific blockchain.

At step 820, an entity private key/wallet address pair associated with a specific sports entity is created to interact with the smart contract and store at least a portion of the player data associated with the specific player on the blockchain.

At step 830, a smart contract for player data associated with a relationship between a specific player and a specific sports entity in a player history database is created.

At step 840, a new NFT in a series on the specific blockchain according to new player data is generated using the smart contract and authorized by the entity private key/wallet key pair of the specific sports player or the specific sports entity to activate the sports history.

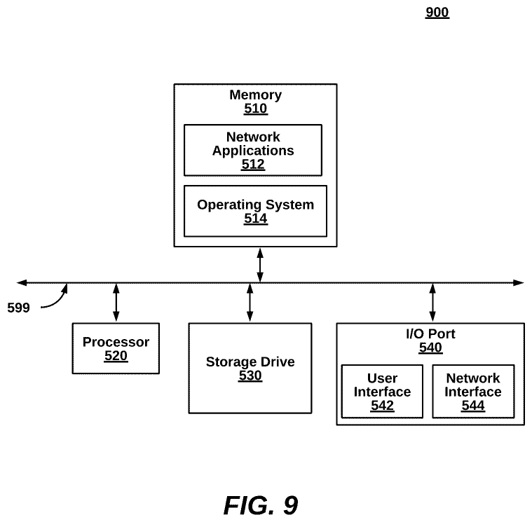

### III. Computing Device for Sports Player Scouting (FIG. 9)

FIG. 9 is a block diagram illustrating a computing device 9500 for use in the system 100 of FIG. 1, according to one embodiment. The computing device 900 is a non-limiting example device for implementing each of the components of the system 100, including NFT engine 110, sports player scouting module 120, player device 130 and scouter device 140. Additionally, the computing device 500 is merely an example implementation itself, since the system 100 can also be fully or partially implemented with laptop computers, tablet computers, smart cell phones, Internet access applications, and the like.

The computing device 900 of the present embodiment, includes a memory 510, a processor 520, a hard drive 530, and an I/O port 540. Each of the components is coupled for electronic communication via a bus 599. Communication can be digital and/or analog and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access applications, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X etc., Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

1. A computer-implemented method in a system, on a data communication network, for providing immutable sports player history transactions within a non-fungible cryptographic token (NFT) based sports player history, the method comprising:
creating a player private key/wallet address pair associated with a specific player to interact with the system, wherein the player private key/wallet address pair is associated with a specific blockchain;
creating an entity private key/wallet address pair associated with a specific sports entity to interact with the smart contract and store at least a portion of the player data associated with the specific player on the blockchain;
creating a smart contract for player data associated with a relationship between a specific player and a specific sports entity in a player history database;
generating a new NFT in a series on the specific blockchain according to new player data using the smart contract and authorized by the entity private key/wallet key pair of the specific sports player or the specific sports entity to activate the sports history; and
sending the NFT to the player private key/wallet pair address.

2. A non-transitory computer-readable medium in a rental verification system, on a data communication network, storing code that when executed, performs a method for providing immutable sports player history transactions within a non-fungible cryptographic token (NFT) based sports player history, the method comprising:
creating a player private key/wallet address pair associated with a specific player to interact with the system, wherein the player private key/wallet address pair is associated with a specific blockchain;
creating an entity private key/wallet address pair associated with a specific sports entity to interact with the smart contract and store at least a portion of the player data associated with the specific player on the blockchain;
creating a smart contract for player data associated with a relationship between a specific player and a specific sports entity in a player history database; and
generating a new NFT in a series on the specific blockchain according to new player data using the smart contract and authorized by the entity private key/wallet key pair of the specific sports player or the specific sports entity to activate the sports history.

3. A rental verification system, on a data communication network, for providing immutable sports player history transactions within a non-fungible cryptographic token (NFT) based sports player history, the rental verification system comprising:
a processor;
a network interface communicatively coupled to the processor and to a data communication network; and
a memory, communicatively coupled to the processor and storing:
a first module to create a player private key/wallet address pair associated with a specific player to interact with the system, wherein the player private key/wallet address pair is associated with a specific blockchain;
a second module to create an entity private key/wallet address pair associated with a specific sports entity to interact with the smart contract and store at least a portion of the player data associated with the specific player on the blockchain;
a third module to create a smart contract for player data associated with a relationship between a specific player and a specific sports entity in a player history database; and
a fourth module to generate a new NFT in a series on the specific blockchain according to new player data using the smart contract and authorized by the entity private key/wallet key pair of the specific sports player or the specific sports entity to activate the sports history.
